(19) United States
(12) Patent Application Publication
(10) Pub. No.: US 2022/0394024 A1
(43) Pub. Date: Dec. 8, 2022

(54) Application Flow Adjustment

(71) Applicant: Capital One Services, LLC, McLean, VA (US)

(72) Inventors: Mykhaylo Bulgakov, Arlington, VA (US); Andrea Montealegre, Arlington, VA (US); Abdelkader M'Hamed Benkreira, Brooklyn, NY (US)

(21) Appl. No.: 17/340,663

(22) Filed: Jun. 7, 2021

(51) Int. Cl. H04L 29/06; H04L 29/08; H04L 12/24

(52) U.S. Cl. CPC H04L 63/08; H04L 67/16; H04L 41/0654

(57) ABSTRACT

A system, method, and computer-readable medium for authenticating users to a service are described. These may have the effect of improving the user's ability to know, before repeatedly attempting to log into the service, that the service is unavailable for receiving authentications. The user may be alerted with that information by a credentials manager handling the user's credentials and either directly or indirectly attempting to authenticate to the service using the user's credentials. The credentials manager may include, but not limited to, tables storing previous results of authentication attempts to the service and/or known authentication credentials for authenticating to a test account associated with the service.

### FIELD OF USE

Aspects of the disclosure relate generally to assisting users in authenticating to services.

### BACKGROUND

For most computer users, managing multiple sets of authentication credentials is difficult. Some users use applications that may assist with storing their separate sets of authentication credentials. An issue created by the use of credentials management applications is that users, who use those credentials management applications, may more easily lock themselves out of their accounts based on the simplicity of repeatedly requesting the credentials management applications to resend their credentials to the service providers, regardless of whether those service providers are able to grant authentication requests.

### SUMMARY

Aspects described herein may address these and other problems, and generally improve how users authenticate to services using their credentials (e.g., username, password, or other credentials). The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for a credentials manager to assist multiple users authenticate to each of the users' separate accounts from various services while notifying them when a given service is not accepting credentials. This may have the effect of improving users' experiences with authenticating to the services as well as improving the consistency by which users authenticate to those services, thus reducing or eliminating user time consumed in making repeated ineffective requests as well as reducing the number of authentication attempts using incorrect user credentials. According to some aspects, these and other benefits may be achieved by a credentials manager storing results of previous authentication attempts, storing known authentication credentials for test accounts for the services that are not associated with a specific user, and determining, based on one or more of results of the previous authentication attempts or on a result of a new authentication attempt using the test account's credentials, whether the service is currently granting access to accounts. In implementation, the ability to assist users authenticate to services may be effected by using a credentials manager that, using software on a user's device to determine when a user interface is displayed on a user's device with regards to entering user specific information (e.g., payment information), separately obtains the authentication information for the user, authenticates to the service (e.g., a credit institution) using the user's credentials, obtains information, and populates the user interface with the information from the service. Where the service fails to authenticate the user based on the supplied credentials, the credentials manager determines an authentication capability of the service and, if the service is not authenticating users, reports the status to the user, thereby permitting the user to select another service while not further attempting to authenticate to the identified service.

According to some aspects, these and other benefits may be achieved by using a computer-implemented method that may comprise causing, by a credentials management system, display of a list of selectable services; receiving, from a user, a selection of a service from the list of selectable services; retrieving, from a storage associated with the credentials management system, user credentials corresponding to a user account associated with the selected service; sending, to a remote computer system associated with the selected service, a request to authenticate to the user account using the user credentials; determining a failure to authenticate, based on the request to authenticate using the user credentials, with the user account of the selected service; determining an authentication capability of the remote computer system to authenticate at least one other account associated with the selected service. The method may further comprise removing, based on determining that the remote computer system is not able to authenticate the at least one other account, the selected service from the list of selectable services to generate a modified list of selectable services.

A system of one or more computers may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions. As such, corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device and system architecture that may be used in implementing one or more aspects of the disclosure in accordance with one or more illustrative aspects discussed herein;

FIG. 2 depicts a block diagram of an environment in which systems and/or methods described herein may be implemented;

FIG. 3 depicts a block diagram of a client device authenticating with a service and receiving information from that service;

FIG. 4 depicts a flowchart showing a process for determining whether a failure to authenticate was based on the user's credentials or based on unavailability of the selected service;

FIG. 5 depicts a flowchart for comparing an authentication failure using the user's credentials with results of other login attempts to the same selected service;

FIG. 6 depicts a flowchart for authenticating to a service using known credentials; and

FIG. 7 depicts a flowchart for storing the results of attempted authentications to a service.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for improving user authentication to a service by checking whether the service is capable of authenticating users to user accounts. As discussed further herein, this combination of features may allow for improved interactions between a user and a computing device and reduced network traffic for redundant authentication requests where no authentication capability exists. One or more aspects of this description comprise a credentials manager configured to store a user's authentication credentials for various accounts associated with service providers. Further, the credentials manager may keep a log when other users have attempted to authenticate to the same service and may store known credentials for accessing test accounts associated with the service providers. Using the known credentials may be relevant in situations where the credentials manager needs to verify that that a given service is accepting authentications where the log of recent authorization attempts by other users is either incomplete or older than a threshold (e.g., a few minutes or hours) to reliably indicate that a specific service is currently accepting or not accepting authentications.

For example, one or more aspects attempt to address situations including the following failed login attempts by a user. Some months ago, the user may have willingly permitted a friend to login to that user's account with a specific service (e.g., a movie streaming service) by providing that friend with the user's password to the service. While that friend was watching a movie provided by the service (or otherwise accessing the specific service), the specific service prompted for an updated password. To keep watching the movie, the friend updated the password but failed to alert the user that the user's password has changed. Later, the user attempted to access the service using the old password and the authentication attempt failed. The user, believing the old password was still valid and that the issue must have been a temporary issue with the service, continued to attempt to authenticate to the service, only to be locked out of the account after a given number of attempts. Eventually, the user needed to call the service's assistance line and request the account be unlocked and a new password set.

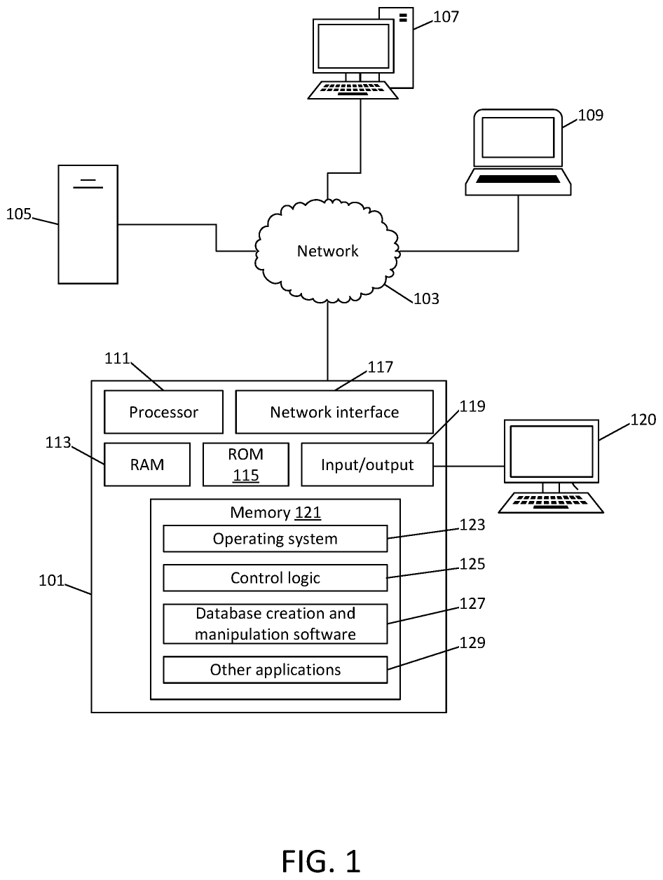

Using the credentials manager as described herein, the credentials manager may have been able to prevent the user's account from being locked by attempting to verify whether the service is, in fact, currently authenticating users to the service. The verification may be independent of a path between any entity and the service or the verification may comprise comparing paths between the entity attempting to authenticate and one or more authentication servers of the service. The verification may comprise checking a log of other attempted authentications to that service and/or independently attempting to authenticate to that service using credentials known by the credentials manager to be current for accessing a test account of the service. The credentials manager may check for actual authentications, not only the ability to submit authorization credentials. At times, even though a service may provide a user interface by which a user may input and submit authentication credentials, that service may be not actually be able at that time to permit authentication to the user's account. The result is that the user is not authenticated to the service and the user's login attempt and subsequent login attempts may be interpreted by the service as someone other than the user attempting to login to the user's account by guessing the user's password. The credentials manager may reduce or eliminate situations where the users are locked out of their accounts based on multiple failed login attempts. Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, the computing device 101 may, in some embodiments, implement one or more aspects of the disclosure by reading and/or executing instructions and performing one or more actions based on the instructions. In some embodiments, the computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

The computing device 101 may, in some embodiments, operate in a standalone environment. In others, the computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109, and other devices (not shown) may be connected to one or more of the networks via twisted pair wires, coaxial cable, fiber optics, radio waves, or other communication media. Additionally or alternatively, the computing device 101 and/or the network nodes 105, 107, and 109 may be a server hosting one or more databases.

As seen in FIG. 1, the computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with database operations. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of the computing device 101, control logic 125 for instructing the computing device 101 to perform aspects discussed herein, database creation and manipulation software 127 and other applications 129. Control logic 125 may be incorporated in and may be a part of database creation and manipulation software 127. In other embodiments, the computing device 101 may include two or more of any and/or all of these components (e.g., two or more processors, two or more memories, etc.) and/or other components and/or subsystems not illustrated here.

Devices 105, 107, 109 may have similar or different architecture as described with respect to the computing device 101. Those of skill in the art will appreciate that the functionality of the computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125 and/or software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) Python or JavaScript. The computer executable instructions may be stored on a computer readable medium such as a hard disk, optical disk, removable storage media, solid-state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product. Having discussed several examples of computing devices which may be used to implement some aspects as discussed further below, discussion will now turn to a method for verifying an authentication capability for a service.

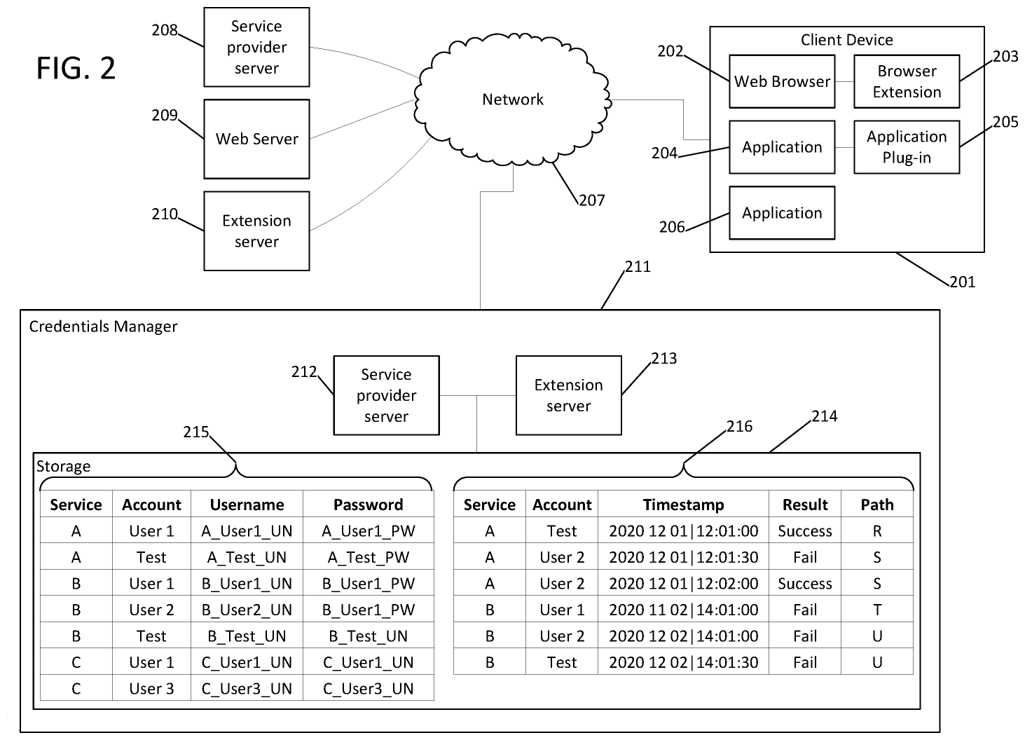

FIG. 2 is a block diagram of an environment in which systems and/or methods described herein may be implemented. As shown in FIG. 2, the environment may include a client device 201, a service provider server 208, a web server 209, and an extension server 210, each interconnected via a network 207. The devices, servers, and network of the environment may interconnect via wired connections, wireless connections, or a combination of wired and wireless connections.

The client device 201 may include a web browser 202 and a browser extension 203. Additionally or alternatively, the client device 201 may include an application 204 providing access to a service, for example, a merchant, employer, or service provider. The access may be via the Internet (for instance, over the World Wide Web, over an API, or other known network or combinations thereof). An application plug-in 205 is configured to work with the application 204 and provides features to the user in addition to the features of the application 204. Additionally or alternatively, the client device 201 may include a separate application 206 that interacts with one or more of the web browser 202 and/or the application 204. For instance, the browser extension 203, the application plug-in 205, and/or the separate application 206 may monitor what is displayed on a display screen of the client device 201 (e.g., displayed by the web browser 202 and/or the application 204) and, based on what is displayed, provide the user with one or more options and/or one or more services.

Client device 201 may comprise a device that supports web browsing. For example, client device 201 may include a computer (e.g., a desktop computer, a laptop computer, a tablet computer, a handheld computer, and/or the like), a mobile phone (e.g., a smart phone and/or the like), a television (e.g., a smart television), an interactive display screen, and/or a similar type of device. Client device 201 may host the web browser 202 and/or the browser extension 203 installed on and/or executing on the client device 201.

The web browser 202 may be used to access information on the World Wide Web, such as web pages, images, videos, and/or other web resources. The web browser 202 may access such web resources using a uniform resource identifier (URI), such as a uniform resource locator (URL), a uniform resource name (URN), and/or the like. Web browser 202 may enable the client device 201 to retrieve and present, for display, content of a web page.

The browser extension 203 may include an application, executing on the client device 201, capable of extending or enhancing functionality of the web browser 202. For example, the browser extension 203 may be a plug-in application for the web browser 202. The browser extension 203 may be capable of executing one or more scripts (e.g., code, which may be written in a scripting language, such as JavaScript and/or C++ or the like) to perform an operation in association with the web browser 202.

The web server 209 may include a device capable of serving web content (e.g., web documents, HTML, documents, web resources, images, style sheets, scripts, text, and/or the like). For example, the web server 209 may include a server and/or computing resources of a server, which may be included in a data center, a cloud computing environment, and/or the like. The web server 209 may process incoming network requests (e.g., from client device 201) using HTTP and/or another protocol. The web server 209 may store, process, and/or deliver web pages to the client device 201. In some implementations, communication between the web server 209 and the client device 201 may take place using HTTP.

The extension server 210 includes a device capable of communicating with client device 201 to support operations of browser extension 203. For example, extension server 210 may store and/or process information for use by browser extension 203. As an example, extension server 210 may store a list of domains applicable to a script to be executed by browser extension 203. In some implementations, client device 201 may obtain the list (e.g., periodically, based on a trigger, and/or the like), and may store a cached list locally on client device 201 for use by browser extension 203.

The network 207 may include one or more wired and/or wireless networks. For example, network 207 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment may perform one or more functions described as being performed by another set of devices of environment. Network 207 may be represented as a single network but may comprise combinations of other networks or subnetworks.

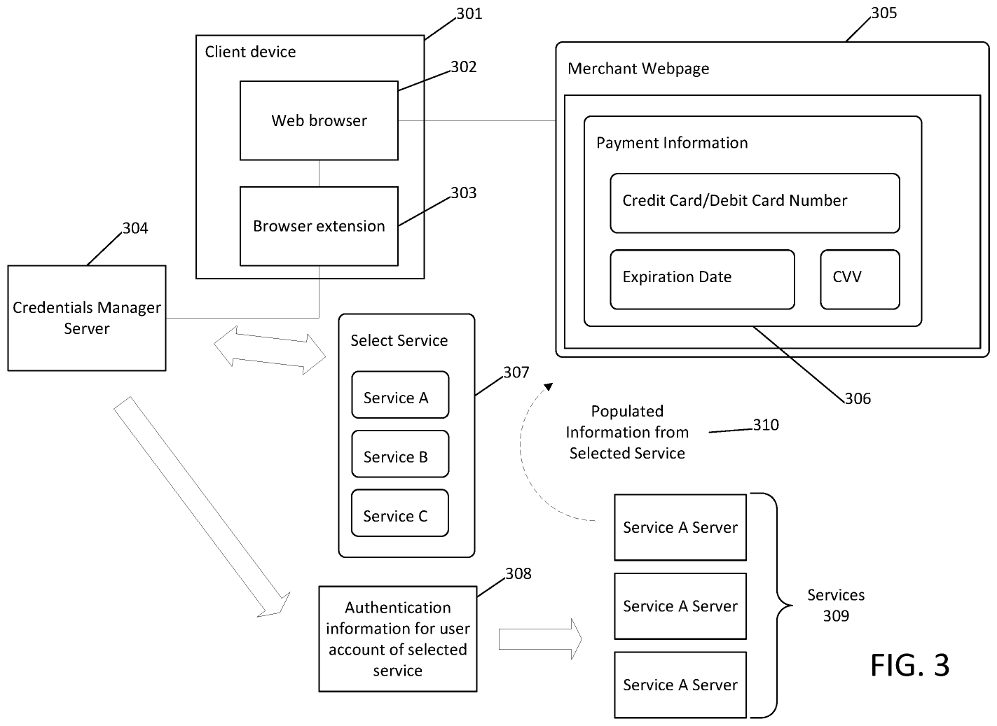

FIG. 2 may further comprise a credentials manager 211. The credentials manager may comprise one or more of a service provider server 212 and/or an extension server 213. One or more of the applications 204 or 206, the browser extension 203, or the application plug-in 205 may communicate with the credentials manager to provide credentials-related services to the user of the client device 201. The credentials manager 211 may further comprise a storage (e.g., in a file system and/or database) authentication credentials for one or more accounts and/or a log of recent login attempts to services. As shown in FIG. 3, the storage 214 may include a table or tables 215 comprising authentication credentials for one or more users. Here, the credentials include a username and a password for each user (or other credentials as relevant to the service—e.g., a personal identification number or code) associated with each user's account on a given service. For instance, for Services A-C, authentication credentials (e.g., a username and password) for users 1-3 are stored as associated with the user's account for the respective service.

In addition to the user authentication credentials for users' accounts, the table or tables 215 may further comprise known credentials for one or more test accounts of the credential manager 211 associated with the services. The known credentials may be maintained by the credentials manager 211 for test accounts with the services. The test accounts may be used by the credentials manager 211 to check whether a service (e.g., provided by service provider server 208) is accepting authentications. If the credential manager 211 attempts to login to one or more test accounts associated with of the credential manager 211's test accounts and the login attempt is not successful, the credential manager 211 may determine that the service is not accepting authentications at a current time. Because the known credentials are known to be correct for a service (either as managed by the credentials manager 211 or some other entity or even the service itself), the failure of the credential manager 211 to login using correct credentials must mean that the service is unavailable. The table or tables 215 may be one table or sets of tables partitioned for instance, by each service, the user, the username or password or other factor or combination of factors.

Table or tables 216 in storage 214 may comprise a log of when users' accounts or test accounts were attempted to be authenticated with for the various services along with timestamps and authentication results. The table or tables 216 may be one table or sets of tables partitioned for instance, by each service, time, result or other factor or combination of factors. The table or tables 216 may comprise all login attempts for the accounts (user and test accounts) or comprise one or more of only successful logins, only unsuccessful logins, only attempted logins over an interval (e.g., over the past hour, past 24 hours, past week, etc.), or a combination thereof. The table or tables 216 may be used to determine when and how many login attempts were successful (or not successful) for a specific service. The credentials manager 211 may, based on recent results from the table or tables 216, be able to identify that a specific service is or is not currently capable of accepting authentication requests. If the table or tables 216 do not have recent information for a specific service, the credentials manager may obtain known authentication credentials from table or tables 215 for a test account associated with that service and attempt to authenticate to that test account. The result of that authentication attempt may be subsequently stored in table 216. The table or tables 216 may comprise the results regardless of a path between the credentials manager 211 and authentication servers associated with a specific service (e.g., the service provider server 208). Alternatively, for some or all of the stored results in the table or tables 216, the path for that specific authentication attempt may be stored. For instance, if all authentication attempts are made by the credentials manager 211 using the same IP path to the network 207 and/or through the network 207 to a given service, the paths may be identical and not stored. Alternatively or additionally, the path may be stored to at least provide an indication of how far along a given path each authentication request progressed until a network connection to an authentication server of the service was no longer available. This storing of partial path information may permit a determination, by the credentials manager 211, that the authentication request never reached the authentication server of the service. Additionally or alternatively, the path information may be stored and useful where the client device 201 itself makes the authentication request to the service. In this example, after the user selects specific service, the credentials manager 211 may provide the authentication information from the table or tables 215 for that user for that service to the client device 201 for the client device 201 to attempt to authenticate to the selected service. In this example, the result of the authentication attempt may be forwarded by the client device 201 to the credentials manager 211 for storing that result in table or tables 216 with the path between the client device 201 and the service (e.g., the authentication server of the service). In some situations, the client device may not be able to determine the path or the client device may not forward the path to the credentials manager. This may result in the table or tables 216 including path information for only some of the authentication attempts.

FIG. 3 depicts a block diagram of a client device authenticating with a service and receiving information from that service. FIG. 3 includes a client device 301 with a web browser 302 and a browser extension 303. The browser extension 303 may be a credentials management browser extension that assists a user of the client device 301 to authenticate to the user's account or accounts associated with the one or more externally-provided services. The browser extension 303 may interact with a credentials manager server 304 that stores the user's credentials and provides them as requested directly or indirectly by the user. For example, the user may be navigating, via the web browser 302, a merchant's webpage 305. That webpage may display a user interface 306 for accepting payment information for purchasing a product (and/or service, subscription and the like) from the merchant.

When the browser extension 303 observes, through monitoring web browser 302, the display of the payment information user interface 306, the browser extension 303 displays a user interface 307 that prompts the user to select a service relating to the payment information user interface 306. For example, service A may relate to a first credit card issuer providing a first credit card (e.g., using the MasterCard/Visa clearinghouse), service B may relate to a second credit card issuer providing a second credit card using a different clearinghouse, and service C may relate to a debit card provided by a financial institution. These services are merely examples and others may be used as well or in place of any of these identified services.

Once the user selects one of the services in user interface 307, the browser extension 303 provides that selection to credentials manager server 304. The credentials manager server 304 obtains user credentials (e.g., from storage 214) relating to the user to access a specific account of the user provided by the selected service. For purposes herein, the user credentials are also referred to as authentication information for the user account. The authentication information 308 is sent from the credentials manager server to a system handling authentication requests for that particular service. In FIG. 3, the services 309 are generally represented by a service A server supporting authentication services for Service A, a service B server supporting authentication services for Service B, and a service C server supporting authentication services for Service C.

If the authentication information 308 properly authenticates the user to the user's account on the selected service, requested information 310 from the selected service is provided to the user interface 306 (e.g., from the selected service to the credentials manager server 304, to the browser extension 303, and then to the web browser 302, for subsequent processing by the merchant's website). Where user interface 306 was to receive payment information, the requested information 310 may comprise payment information to complete the transaction with the merchant. The requested information 310 may comprise a static credit card number, expiration date, and credit card verification value or may provide, for instance, single-use payment information, generated by the selected service or third-party (e.g., the Mastercard clearinghouse) based on instruction from the selected service.

In some situations, the user's credentials may be rejected by the selected service, either directly (as a message that the user's password is incorrect and/or a user's account does not exist for that service) or indirectly (as the service not responding to the authentication request within a given period of time—e.g., the request having timed out). In certain of those instances, the user's credentials may, in fact, be incorrect as the user may have unknowingly changed the password and that information was not subsequently pushed to the credentials manager server 304. In other instances, the user's credentials may, in fact, be correct but the communication links between the user's device and the respective authentication server for the selected service may be unavailable.

In some instances, authentication servers for services may provide an operable user interface or API, permitting users' credentials to be received (and increment a count of authorization requests based on the receipts of the credentials) while being unavailable to authenticate the users with valid credentials. Users with valid credentials may continue to attempt to authenticate to those servers and continue to receive rejections. Those rejections may accumulate and the users be locked out of their own accounts, not for having incorrect credentials, but for repeatedly trying to use a service having authentication servers that are unable to properly authenticate them to the service.

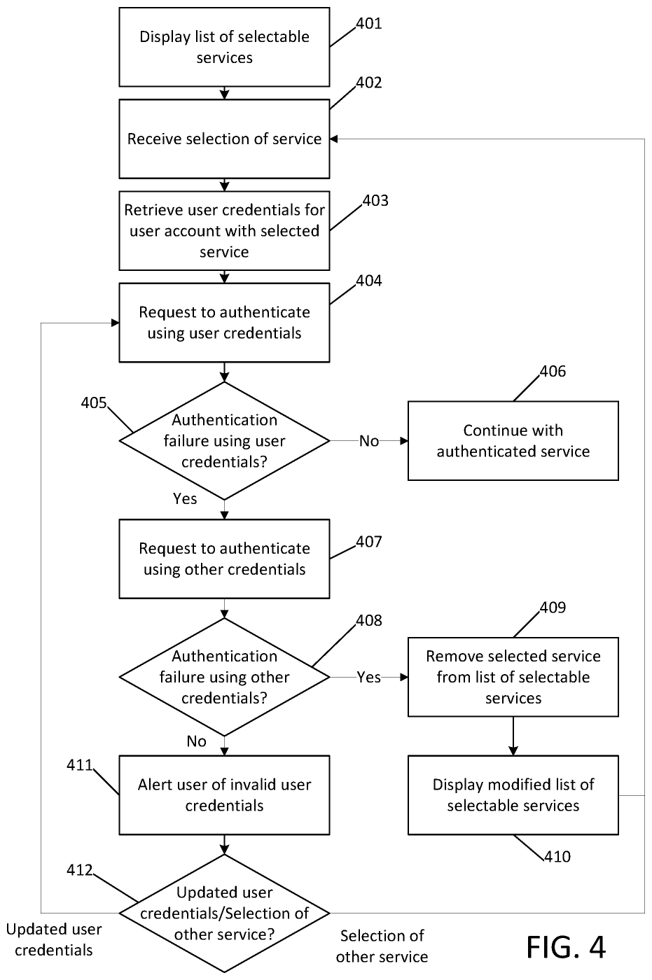

One or more aspects relate to determining whether those communication links are, in fact, unavailable before modifying the list of selectable services or prompting the user to change his password. FIG. 4 depicts a flowchart showing a process for determining whether a failure to authenticate was based on the user's credentials or based on unavailability of the selected service (e.g., the unavailability of an authentication server or viable pathway to the authentication server). In step 401, a user is provided (e.g., in a browser window on a display of a user's device) with a list of selectable services. The list from step 401 may be generated in response to a browser extension (e.g., the browser extension 303) determining that a user interface 306 is displayed for receiving, from the user, payment information (e.g., credit card information). In step 402, a user selection of one of the services is received. In step 404, a request to authenticate to the select service using user credentials associated with a user's account with the selected service is sent. The request may be sent by a credentials manager server 304, by the client device 301, or another device. If the request is sent by the client device 301 or another device, those devices may have been instructed to send the authentication request by the credentials manager server 304.

In step 405, the system determines whether the authentication request has failed. If the authentication was successful, the system continues with the authenticated service as shown in step 406. The use of the authenticated service in step 406 may comprise the authenticated service providing the payment information 310 for population in the payment information user interface 306. If there was an authentication failure in step 405, the system sends, in step 407, a request to authenticate to the selected service using other credentials. If it is determined in step 408 that the authentication using the other credentials has also failed, the selected service may be removed from the list of selectable services in step 409 and a modified list of selectable services is displayed to the user in step 410, to await the user selection of one of those services in step 402. Further, if available, the determination in step 405 may comprise reading returned information regarding the rejection of the request to authenticate including, but not limited to, information in the header of the rejection message from the authentication server. That information may be used to skip one or more steps as that information may provide a reason why the authentication failed.

If the authentication using the other credentials was determined in step 408 to not have failed (e.g., to have been successful), then in step 411 the system alerts the user that the user's credentials are invalid. In step 412, the user may be provided with an option to update the user credentials or select another service from the list of services. If the user updates the user credentials, the browser extension 303 may prompt and/or monitor the user's interaction with the selected service and record the new credentials for the user account associated with that service. Next, those updated credentials may be used in step 404. If the user selects another service, the selection may be received in step 402 and credentials for that other service retrieved (in step 403) and then sent (in step 404) to that newly selected service for authentication.

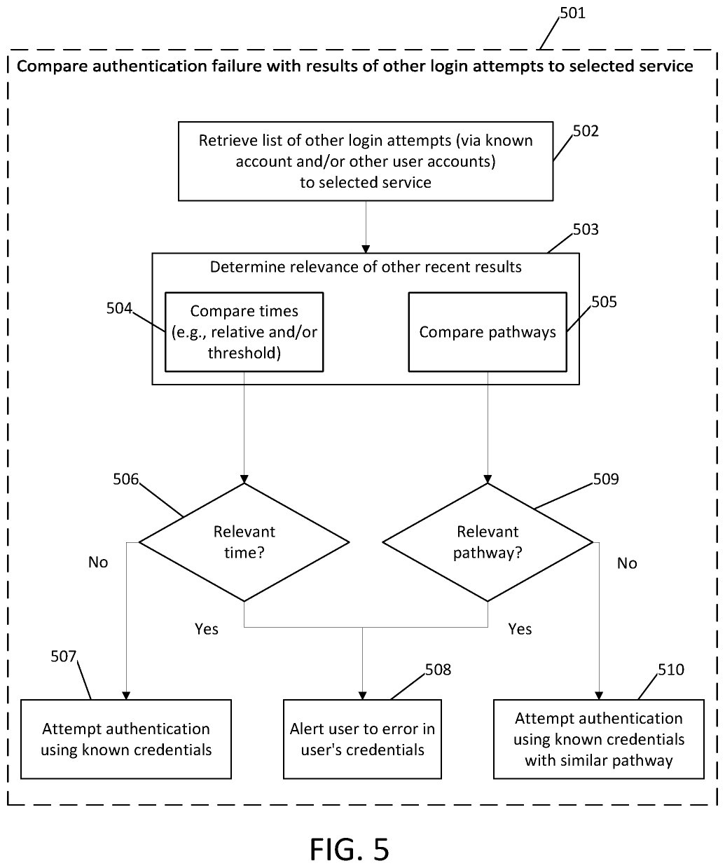

FIG. 5 depicts a flowchart for comparing an authentication failure using the user's credentials with results of other login attempts to the same selected service. The comparison 501 may comprise retrieving, in step 502, a list of other login attempts to the select service. The list of other login attempts may include attempted logins to test accounts using known credentials (e.g., credentials known to the credentials manager server 304 to be authentic) and/or to other user's accounts using those other user's credentials. The list may comprise a list of recent login attempts (e.g., attempts within the last few minutes through attempts within the last few hours), a list of timestamped logins over a past interval (e.g., hour, day, week, month, etc.), successes and/or failures of those login attempts, and/or pathways between the device requesting authentication (e.g., client devices 301 and/or the credentials management server 304).

In step 503, the system determines the relevance of other recent results. The determination may comprise step 504 in which the time between the user's failed login attempt and other users' login attempts are compared to each other. The comparisons may be relative to the time (comparisons 504) of the user's failed login attempt (if other users are successfully logging into the same selected service, the authentication server for that service must be available) and/or based on a threshold or ratio (if 50% or more users are able to authenticate), then the authentication server for that service may be determined in step 506 to be generally available. If most recent login attempts resulted in failures and only older login attempts were successful, then in step 506 then the service may be determined to be generally unavailable.

The comparisons may also be relative to the path between the devices requesting login and the authentication server for the service (e.g., step 505). If, for instance, the successful authentications for the selected service followed a generally similar IP path from the requesting devices (e.g., same cell phone network or same geographic vicinity) to the authenticating server, then the service may be determined in step 509 to be generally available. If the successful authentications for the selected service had distinctly different pathways (e.g., all from a different cell phone network or all from a different region of the country or world), then the service may be determined in step 509 to be generally unavailable.

If the recent login attempts have been of other users and if those attempts were not generally successful (e.g., more than 50% success rate), then the system may attempt to log into the selected service using known credentials of the test account (step 507). If the recent login attempts had a distinct pathway, not in common with that of the current user, then the system may attempt to log into the selected service using known credentials and a pathway similar to that used by the user (step 510).

With respect to the pathway analysis, the pathways may be dependent on whether the client device 301 is sending the login request directly to the selected service's authentication server or via the credentials manager server 304. Where sent directly, the credentials manager server 304 may have previously forwarded the retrieve users credentials for the user of the selected service to the user's account.

If the credentials manager 211 determines that others have successfully authenticated to the server (e.g., based on a relevant time in step 506 or based on a relevant pathway 509 or both), then the credentials manager 211 may determine that the failure to authenticate is based on incorrect authentication credentials. The user maybe alerted in step 508 that the authentication attempt failed and that the user's credentials are incorrect. Additionally or alternatively, the user may be presented with a password reset user interface to permit the user to reset the user's password. The password reset user interface may be generated by the service itself, by the credentials manager 211, and/or the browser extension 303 as a user interface provided by browser 302 or as an overlay by browser extension 303. Once the user resets the password for that service, the new password may be captured by the browser extension 303 and forwarded to credentials manager 211 for storage in the authentication credentials table or tables 215.

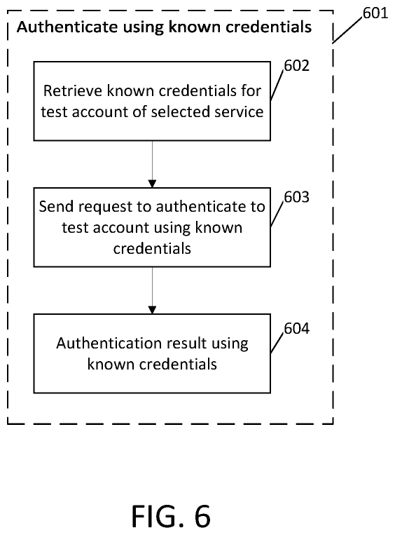

FIG. 6 depicts a flowchart for authenticating to a service using known credentials. The process 601 of FIG. 6 comprises retrieving, in step 602, known credentials for a test account of a selected service, e.g., from the authentication credentials table or tables 215. The test account may comprise an account created by the credentials manager server 304 with a specific service (e.g., one of Service A, Service B, Service C of FIG. 3) and/or a test account created by the service (e.g., one of Service A, Service B, Service C of FIG. 3) with credentials forwarded to the credentials manager server 304. The credentials for the test account are referred to herein as “known” as they are assured to be accurate. In step 603, an authentication request may be sent (step 603) using the known credentials. In step 604, the credentials manager attempts to authenticate to the test account of the service using the known credentials.

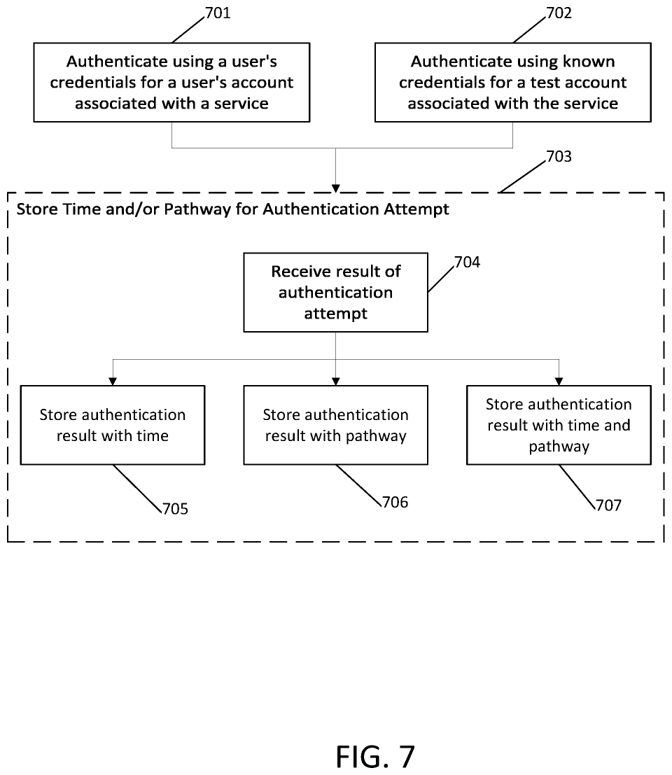

FIG. 7 depicts a flowchart for storing the results of attempted authentications to a service. As shown in FIG. 7, an authentication attempt may have been performed (step 701) based on a user's credentials for the user's account associated with a service. Additionally or alternatively, an authentication attempt may have been performed (step 702) based on known credentials for a test account associated with the service. Based on either of steps 701 or 702 occurring, the process of step 703 of storing the time and/or pathway and result of the authentication result of steps 702 and/or 703 may be performed. It is appreciated that steps 701 and 702 may occur in any order or repeatedly without the other while step 703 is subsequently performed.

In step 703, the result of the authentication attempt (either of steps 701 or 702 or both 701 and 702) is received (step 704). In step 705, the result of the authentication attempt is stored with the time of the authentication attempt. Additionally or alternatively, in step 706, the result of the authentication attempt is stored with the pathway of the authentication attempt. Additionally or alternatively, in step 707, the result of the authentication attempt is stored with both the time and the pathway of the authentication attempt. In each of steps 705, 706, and 707, the results may be stored in table 215 of storage 214 of the credentials manager 211.

Thus, a computer-implemented method may comprise causing, by a credentials management system, display of a list of selectable services; receiving, from a user, a selection of a service from the list of selectable services; retrieving, from a storage associated with the credentials management system, user credentials corresponding to a user account associated with the selected service; sending, to a remote computer system associated with the selected service, a request to authenticate to the user account using the user credentials; determining a failure to authenticate, based on the request to authenticate using the user credentials, with the user account of the selected service; determining an authentication capability of the remote computer system to authenticate at least one other account associated with the selected service. The method may further comprise removing, based on determining that the remote computer system is not able to authenticate the at least one other account, the selected service from the list of selectable services to generate a modified list of selectable services.

Further, the method may comprise receiving a request to authenticate a user device of the user to the selected service. The method's determining the authentication capability of the remote computer system may comprise retrieving, from a remote storage, a list of recent login attempts to authenticate to other user accounts of the selected service, wherein the recent login attempts were based on other user credentials; and determining attempted authentication results associated with the list of recent login attempts. The attempted authentication results may comprise one or more of a recent successful login, a recent unsuccessful login, or a ratio between recent successful logins and recent unsuccessful logins. The attempted authentication results may comprise times at which the recent login attempts were initiated.

The authentication capability of the remote computer system may comprise obtaining known credentials for a test account of the selected service; sending, to the remote computer system associated with the selected service, a request to authenticate to the test account using the known credentials; and receiving information identifying whether authenticating, using the known credentials, was successful. The method may further comprise storing, in a list of recent login attempts, the received information that authenticating using the known credentials was successful. The method may further comprise determining a user connection pathway associated with the sending the request to authenticate to the user account using the user credentials; determining a test connection pathway associated with the sending the request to authenticate, using the known credentials, to the test account; comparing the user connection pathway and the test connection pathway; and determining, based on the comparison of the user connection pathway and the test connection pathway, whether to inform the user of a result of authenticating using the known credentials. The method may further comprise causing, based on the determination of the authentication capability, display of a credentials update user interface; receiving, based on interaction with the credentials update user interface, updated user credentials; and storing, for the user account of the selected service, the received updated user credentials. The causing display of the credentials update user interface may be based on monitoring for display of a first user interface of the selected service, wherein the first user interface is configured to receiving updated user credentials. The causing display of the credentials update user interface may comprise causing display of a credentials management user interface configured to receive the updated user credentials. The method may further comprise causing population, based on the received updated user credentials, the first user interface of the selected service with the received updated user credentials.

The method may further comprise monitoring, via a first application executing on a user device, user interactions with a second application of the user device; identifying, in the second application as displayed to the user, a user interface for authenticating to a card issuer; generating, for display on the user device, a selection user interface including the list of selectable services; and causing display of the selection user interface, wherein receiving the selection of the service may include receiving, from the user device, the selection of the service from the displayed list of selectable services. The method may further comprise determining, for the selected service, whether one or more subsequent authentication attempts will lock the user account of the selected service, generating an alert that one or more subsequent authentication attempts will lock the user account of the selected service; and causing display of the alert. The method may comprise determining, based on the determining the failure to authenticate to the user account of the selected service, content in an application programing interface response, and wherein application programing interface response was received after the sending of the user credentials. The method may further comprise reading content of a failure message from the service; determining the read content identifies the user credentials comprise an incorrect password; and determining a time elapsed since a successful login to a second user account of a second user.

The method may further comprise retrieving an elapsed time threshold; determining a time elapsed between since a successful login to a second user account of a second user and a current time; determining whether the time elapsed satisfies the elapsed time threshold; obtaining, based on the determination that the elapsed time threshold has been satisfied, known credentials for a test account of the selected service; sending, to the remote computer system associated with the selected service, the known credentials; and receiving information identifying whether authenticating, to the test account of the selected service using the known credentials, was successful.

An apparatus may comprise one or more processors; and memory storing instructions that, when executed by the one or more processors, cause the apparatus to display of a list of selectable services; receive, from a user, a selection of a service from the list of selectable services; retrieve, from a credentials management system, user credentials corresponding to a user account, of the user, associated with the selected service; send, to a remote computer system associated with the selected service, a request to authenticate to the user account using the user credentials; determine a failure to authenticate, based on the request to authenticate using the user credentials, with the user account of the selected service; determine an authentication capability of the remote computer system to authenticate at least one other account associated with the selected service; remove, based on determining that the remote computer system is not able to authenticate the at least one other account, the selected service from the list of selectable services to generate a modified list of selectable services; and cause display of the list of the modified list of selectable services.

The apparatus may include additional instructions that cause the apparatus to retrieve, from a remote storage, a list of recent login attempts to authenticate to other user accounts of the selected service, wherein the recent login attempts were based on other user credentials; and determine attempted authentication results associated with the list of recent login attempts. Additional instructions may cause the apparatus to obtain known credentials for test account of the selected service; send, to the remote computer system associated with the selected service, the known credentials; and receive information identifying whether authenticating, using the known credentials, was successful. Additional instructions may cause the apparatus to store, in a list of recent login attempts, the received information that authenticating using the known credentials was successful.

One more non-transitory media storing instructions that, when executed by one or more processors, may cause the one or more processors to perform steps comprising monitoring, via a credentials management application executing on a user device, user interactions with one or more other applications executing on the user device; identifying, from the one or more other applications and as displayed to the user, a user interface for authenticating to a card issuer; generating, via the credentials management application and for display on the user device, a selection user interface including a list of selectable services; and causing display of the selection user interface; and receiving, from the user device, the selection of a service from the displayed selection user interface. The instructions may further cause retrieving, from a remote storage associated with the credentials management application, user credentials corresponding to a user account associated with the selected service; sending, to a remote computer system associated with the selected service, a request to authenticate to the user account using the user credentials; determining a failure to authenticate, based on the request to authenticate using the user credentials, with the user account of the selected service; determining an authentication capability of the remote computer system to authenticate at least one other account associated with the selected service; and removing, based on determining that the remote computer system is not able to authenticate the at least one other account, the selected service from the list of selectable services to generate a modified list of selectable services.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
causing, by a credentials management system, display of a list of selectable services;
receiving, from a user, a selection of a service from the list of selectable services;
retrieving, from a storage associated with the credentials management system, user credentials corresponding to a user account associated with the selected service;
sending, to a remote computer system associated with the selected service, a request to authenticate to the user account using the user credentials;
determining a failure to authenticate, based on the request to authenticate using the user credentials, with the user account of the selected service;
determining an authentication capability of the remote computer system to authenticate at least one other account associated with the selected service; and
removing, based on determining that the remote computer system is not able to authenticate the at least one other account, the selected service from the list of selectable services to generate a modified list of selectable services.

2. The computer-implemented method of claim 1, wherein receiving the selection of the service comprises:
receiving a request to authenticate a user device of the user to the selected service.

3. The computer-implemented method of claim 1, wherein determining the authentication capability of the remote computer system comprises:
retrieving, from a remote storage, a list of recent login attempts to authenticate to other user accounts of the selected service, wherein the recent login attempts were based on other user credentials; and
determining attempted authentication results associated with the list of recent login attempts.

4. The computer-implemented method of claim 3,
wherein the attempted authentication results comprise one or more of a recent successful login, a recent unsuccessful login, or a ratio between recent successful logins and recent unsuccessful logins.

5. The computer-implemented method of claim 4,
wherein the attempted authentication results comprise times at which the list of recent login attempts were initiated.

6. The computer-implemented method of claim 1, wherein determining the authentication capability of the remote computer system comprises:
obtaining known credentials for a test account of the selected service;
sending, to the remote computer system associated with the selected service, a request to authenticate to the test account using the known credentials; and
receiving information identifying whether authenticating, using the known credentials, was successful.

7. The computer-implemented method of claim 6, further comprising:
storing, in a list of recent login attempts, the received information that authenticating using the known credentials was successful.

8. The computer-implemented method of claim 6, wherein determining the authentication capability of the remote computer system further comprises:
determining a user connection pathway associated with the sending the request to authenticate to the user account using the user credentials;
determining a test connection pathway associated with the sending the request to authenticate, using the known credentials, to the test account;
comparing the user connection pathway and the test connection pathway; and
determining, based on the comparison of the user connection pathway and the test connection pathway, whether to inform the user of a result of authenticating using the known credentials.

9. The computer-implemented method of claim 1, further comprising:
causing, based on the determination of the authentication capability, display of a credentials update user interface;
receiving, based on interaction with the credentials update user interface, updated user credentials; and
storing, for the user account of the selected service, the received updated user credentials.

10. The computer-implemented method of claim 9,
wherein causing display of the credentials update user interface is further based on monitoring for display of a first user interface of the selected service, wherein the first user interface is configured to receiving updated user credentials,
wherein causing display of the credentials update user interface comprises causing display of a credentials management user interface configured to receive the updated user credentials, and
wherein the computer-implemented method further comprises causing population, based on the received updated user credentials, the first user interface of the selected service with the received updated user credentials.

11. The computer-implemented method of claim 1, further comprising:
monitoring, via a first application executing on a user device, user interactions with a second application of the user device;
identifying, in the second application as displayed to the user, a user interface for authenticating to a card issuer;
generating, for display on the user device, a selection user interface including the list of selectable services; and
causing display of the selection user interface,
wherein receiving the selection of the service further comprises:
receiving, from the user device, the selection of the service from the displayed list of selectable services.

12. The computer-implemented method of claim 1, further comprising:
determining, for the selected service, whether one or more subsequent authentication attempts will lock the user account of the selected service,
wherein modifying the list of selectable services comprises:
generating an alert that one or more subsequent authentication attempts will lock the user account of the selected service; and
causing display of the alert.

13. The computer-implemented method of claim 1,
wherein determining the authentication capability of the remote computer system comprises determining, based on the determining the failure to authenticate to the user account of the selected service, content in an application programing interface response, and
wherein the application programing interface response was received after the sending of the user credentials.

14. The computer-implemented method of claim 1, wherein determining the authentication capability of the remote computer system comprises:
reading content of a failure message from the service;
determining the read content identifies the user credentials comprise an incorrect password; and
determining a time elapsed since a successful login to a second user account of a second user.

15. The computer-implemented method of claim 1, wherein determining the authentication capability of the remote computer system comprises:
retrieving an elapsed time threshold;
determining a time elapsed between since a successful login to a second user account of a second user and a current time;
determining whether the time elapsed satisfies the elapsed time threshold;
obtaining, based on the determination that the elapsed time threshold has been satisfied, known credentials for a test account of the selected service;
sending, to the remote computer system associated with the selected service, the known credentials; and
receiving information identifying whether authenticating, to the test account of the selected service using the known credentials, was successful.

16. An apparatus comprising:
one or more processors; and
memory storing instructions that, when executed by the one or more processors, cause the apparatus to:
display of a list of selectable services;
receive, from a user, a selection of a service from the list of selectable services;
retrieve, from a credentials management system, user credentials corresponding to a user account, of the user, associated with the selected service;
send, to a remote computer system associated with the selected service, a request to authenticate to the user account using the user credentials;
determine a failure to authenticate, based on the request to authenticate using the user credentials, with the user account of the selected service;
determine an authentication capability of the remote computer system to authenticate at least one other account associated with the selected service;
remove, based on determining that the remote computer system is not able to authenticate the at least one other account, the selected service from the list of selectable services to generate a modified list of selectable services; and
cause display of the list of the modified list of selectable services.

17. The apparatus of claim 16, wherein the instructions to determine the authentication capability of the remote computer system further cause the apparatus to:
retrieve, from a remote storage, a list of recent login attempts to authenticate to other user accounts of the selected service, wherein the recent login attempts were based on other user credentials; and
determine attempted authentication results associated with the list of recent login attempts.

18. The apparatus of claim 16, wherein the instructions to determine the authentication capability of the remote computer system further cause the apparatus to:
obtain known credentials for test account of the selected service;
send, to the remote computer system associated with the selected service, the known credentials; and
receive information identifying whether authenticating, using the known credentials, was successful.

19. The apparatus of claim 18, wherein the instructions further cause the apparatus to:
store, in a list of recent login attempts, the received information that authenticating using the known credentials was successful.

20. One or more non-transitory media storing instructions that, when executed by one or more processors, cause the one or more processors to perform steps comprising:
monitoring, via a credentials management application executing on a user device, user interactions with one or more other applications executing on the user device;
identifying, from the one or more other applications and as displayed to the user, a user interface for authenticating to a card issuer;
generating, via the credentials management application and for display on the user device, a selection user interface including a list of selectable services; and
causing display of the selection user interface;
receiving, from the user device, the selection of a service from the displayed selection user interface;
retrieving, from a remote storage associated with the credentials management application, user credentials corresponding to a user account associated with the selected service;
sending, to a remote computer system associated with the selected service, a request to authenticate to the user account using the user credentials;
determining a failure to authenticate, based on the request to authenticate using the user credentials, with the user account of the selected service;
determining an authentication capability of the remote computer system to authenticate at least one other account associated with the selected service; and
removing, based on determining that the remote computer system is not able to authenticate the at least one other account, the selected service from the list of selectable services to generate a modified list of selectable services.
